(19) United States
(12) Patent Application Publication
(10) Pub. No.: US 2011/0026654 A1
(43) Pub. Date: Feb. 3, 2011

(54) NETWORK DEVICE OF HIGH-PRECISION SYNCHRONIZATION TYPE, NETWORK SYSTEM, AND FRAME TRANSFER METHOD

(75) Inventors: Junichi Takeuchi, Kanagawa (JP); Naoto Iga, Kanagawa (JP); Hideki Goto, Aichi-ken (JP); Shinichi Ilyama, Tokyo-to (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: TOYOTA JIDOSHA KABUSHIKI KAISHA, AICHI-KEN (JP); Renesas Electronics Corporation, Kawasaki (JP)

(21) Appl. No.: 12/934,839

(22) PCT Filed: Mar. 25, 2009
(86) PCT No.: PCT/IB09/00590

§ 371 Date: Oct. 15, 2010

(30) Foreign Application Priority Data
Mar. 26, 2008 (JP) 2008-080662

(51) Int. Cl. H04L 7/00

(52) U.S. Cl. 375/356

(57) ABSTRACT

A network device that arranges and transfers in an initial period of a cycle a synchronization frame that synchronizes network devices within a network includes: a cycle timer that measures a time within the cycle and a synchronization management unit that suspends frame transmission for a predetermined period till a start of the next cycle in each cycle, on the basis of information from a cycle timer.

### BACKGROUND OF THE INVENTION

1. Field of the Invention

This invention relates to a network device, a network system, and a frame transfer method.

2. Description of the Related Art

Presently, communication technology such as Institute of Electrical and Electronic Engineers (IEEE) 1394 is used as real-time communication technology. Such communication technology uses a communication system performing cyclic transfer in which real time data and best effort data are mixed (referred to hereinbelow as “cyclic transfer communication”).

In the aforementioned communication system, one cycle has a predetermined period such as shown in FIG. 12, for example, a timeslot of 125 μsec. The timeslots of this period are repeated in a plurality of cycles. Packet data (referred to hereinbelow as “frame”) having a fixed period within this timeslot are transferred between network devices. Here, the interval of the first half of the cycle is taken as a reserved transfer interval and the interval of the second half is taken as a free transfer interval.

In the reserved transfer interval, a fixed period within the interval, for example periods 1 to 5 in FIG. 12, are reserved for frame transmission. The reserved periods 1 to 5 are used only between the respective set devices. For example, in a network configured by a plurality of network devices such as shown in FIG. 13, the period 1 shown in FIG. 12 is reserved for use only for transmission between a device 11 and a device 14, and the period 2 is reserved for use only for transmission between a device 12 and a device 13.

By setting frames A1 to A5 of real time data in the reserved fixed period, such as periods 1 to 5, a fixed amount of frame transmission can be guaranteed within a fixed time interval and real time data such as audio video (AV) data can be transmitted between the devices.

The free transfer interval is used for best effort data communication. In this interval, no frame transmission period is ensured by reservation. As a result, data having no real time property are transferred within this interval. Therefore, where a vacant period, for example, the period 6 is present in this interval, at the point in time the frame transfer is performed, the frame B1 is arranged in this vacant period and data communication between the devices is performed.

Various forms of network configuration can be considered for realizing the cyclic transfer communication system shown in FIG. 12. For example, a daisy-chain connection such as that of network devices 11 to 14 and a star connection such as that of network devices 11, 12, 13, and 15 shown in FIG. 13 can be used.

Each network device has a bridge function, and network devices 12, 13, and 15 can transfer a transmission frame from a network device on one side of the device to a network device on the other side. As a result, communication can be performed by using a bridge function even between the network devices that are not directly connected to each other.

There is a trend to using the above-described cyclic transfer in Ethernet (registered trademark), which is a Local Area Network (LAN) technology standard. Accordingly, a technology ensuring high speed and high reliability of data communication within a network on the basis of a network communication technology performing cyclic transfer communication is sought for a LAN using the Ethernet (registered trademark).

In order to ensure high reliability of such network communication, it is necessary to perform highly precise synchronization of clocks between the network devices within the network. The protocol specified in IEEE 1588 is used when accurate time synchronization between communication devices is necessary. For example, even with the usual Ethernet connection in which real time data communication is not presumed, extremely accurate synchronization equal to or less than a microsecond between the devices can be attained. Therefore, by using the protocol specified by IEEE 1588 in the communication within the aforementioned network, it is possible to synchronize the clocks between the devices in the network with a high precision.

Following the procedure specified by IEEE 1588, one master device that generates a master clock serving as a basis synchronization clock for a plurality of devices within a network is determined in the network. The master device periodically transmits a synchronization frame including time information of the master clock to a plurality of devices within the network. Each network device that received the synchronization frame checks the time information of the master clock contained in the synchronization frame. The difference between the master clock and the clock of the own device is checked, and where a shift therebetween has occurred, a correction is performed to synchronize the clock of the own device with the master clock.

Where the synchronization frame is not periodically sent within the predetermined time due to network congestion or the like, the network devices are not synchronized and an adverse effect is produced on frame transfer in cyclic transfer communication. More specifically, the reserved transfer is performed in a wrong time period, frames collide, and frames are discarded in the reserved transfer interval.

Accordingly, Japanese Patent Application Publication No. 11-298477 (JP-A-11-298477) discloses an invention aimed at increase in transmission efficiency in a network. With this technology, a frame period is specified by a synchronization signal. The transmission between a plurality of communication stations is then performed by a polling control signal in a data transmission region within this frame period.

However, with such a technology, a root node transmits a polling control signal in a data transmission region within this frame period, thereby performing data transfer. Therefore, the network transmission efficiency decreases to a degree corresponding to the transmission of the polling control signal. As a result, network congestion occurs and there is a possibility that synchronization by a synchronization frame will not be performed reliably.

### SUMMARY OF THE INVENTION

The first aspect of the invention relates to a network device that performs a cyclic data transfer, in which transmission data are divided into a plurality of frames and the plurality of frames are transmitted and received in fixed cycles, and arranges and transfers, in an initial period of the cycle, a synchronization frame that synchronizes a plurality of network devices within a network. The network device includes a cycle timer that measures a time within the cycle and a synchronization management unit that suspends frame transmission for a predetermined period, in each cycle, till a start of a next cycle on the basis of information relating to the time measured by the cycle timer.

Because of the above-described configuration, no frame collision occurs in a transfer period of a synchronization frame arranged in the initial region of one cycle. Furthermore, even when network congestion occurs, the synchronization frame can be reliably transferred and synchronization between the devices is reliably performed in cyclic transfer communication.

The network device according to the aspect may discard or temporarily store a frame received in the predetermined period, when a frame received in the predetermined period exists.

The network device according to the aspect may further include a frame check unit that stops transmission of a frame that is being transferred and transmits the synchronization frame when the synchronization frame has been received.

In the network device according to the aspect, the frame that is being transferred may use a transmission port identical to that used for transmitting the synchronization frame.

In the network device according to the aspect, the frame that is being transferred may be discarded or temporarily stored.

The second aspect of the invention relates to a network system in which a cyclic data transfer is performed, in which transmission data are divided into a plurality of frames and the plurality of frames are transmitted and received in fixed cycles, and a synchronization frame that synchronizes a plurality of network devices within the network is arranged and transferred in an initial period of each cycle. In the network system, the network device measures a time within the cycle and suspends frame transmission to another network device, for a predetermined period, in each cycle till a start of a next cycle on the basis of information relating to the measured time.

Because of the above-described configuration, no frame collision occurs in a transfer period of a synchronization frame arranged in the initial region of one cycle.

Furthermore, even when network congestion occurs, the synchronization frame can be reliably transferred and synchronization between the devices is reliably performed in cyclic transfer communication.

In the network system according to the aspect, when a frame received from another network device in the predetermined period exists, the network device may discards or temporarily stores the received frame.

In the network system according to the aspect, when the network device further receives the synchronization frame and a frame that is being transferred to another network device exists, the network device may stop transmission of the frame that is being transferred and preferentially transmit the synchronization frame.

In the network system according to the aspect, the network device may discards or temporarily stores the frame that is being transferred.

The third aspect of the invention relates to a frame transfer method of performing a cyclic data transfer, in which transmission data are divided into a plurality of frames and the plurality of frames are transmitted and received in fixed cycles, and arranging and transferring a synchronization frame that synchronizes network devices within a network in an initial period of each cycle. The frame transfer method includes: measuring a time within the cycle; and suspending frame transmission for a predetermined period in each cycle till a start of a next cycle on the basis of information relating to the measured time.

Because of the above-described configuration, no frame collision occurs in a transfer period of a synchronization frame arranged in the initial region of one cycle. Furthermore, even when network congestion occurs, the synchronization frame can be reliably transferred and synchronization between the devices is reliably performed in cyclic transfer communication.

The frame transfer method may further include discarding or temporarily storing the received frame when a frame received in the predetermined period exists.

The frame transfer method may further include stopping transmission of the frame that is being transmitted when the synchronization frame is received and transmitting the synchronization frame.

In the frame transfer method, the frame that is being transferred may use a transmission port identical to that used for transmitting the synchronization frame.

In the frame transfer method, frame that is being transferred may be discarded or temporarily stored.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements, and wherein:

FIG. 1 is a schematic diagram of a network of Embodiment 1;

FIG. 2 is a block diagram of a network device of Embodiment 1;

FIG. 3 illustrates a timeslot for the explaining problems associated with the related art;

FIG. 4 illustrates a timeslot for the explaining problems associated with the related art;

FIG. 5 shows a shift between the master clock and the clock of the own device for the explaining problems associated with the related art;

FIG. 6 shows a timeslot for explaining the transmission top processing performed by the network device of Embodiment 1;

FIG. 7 is flowchart illustrating the processing performed in the network device of Embodiment 1;

FIG. 8 is block diagram of the network device of Embodiment 2;

FIG. 9 is a schematic diagram of a frame transferred by the network device of Embodiment 2;

FIG. 10 is flowchart illustrating the processing performed in the network device of Embodiment 2;

FIG. 11 is block diagram of the network device of Embodiment 3;

FIG. 12 is flowchart illustrating the reconstruction processing of the network of each embodiment; and

FIG. 13 shows a timeslot of 1 cycle of the usual cyclic network communication.

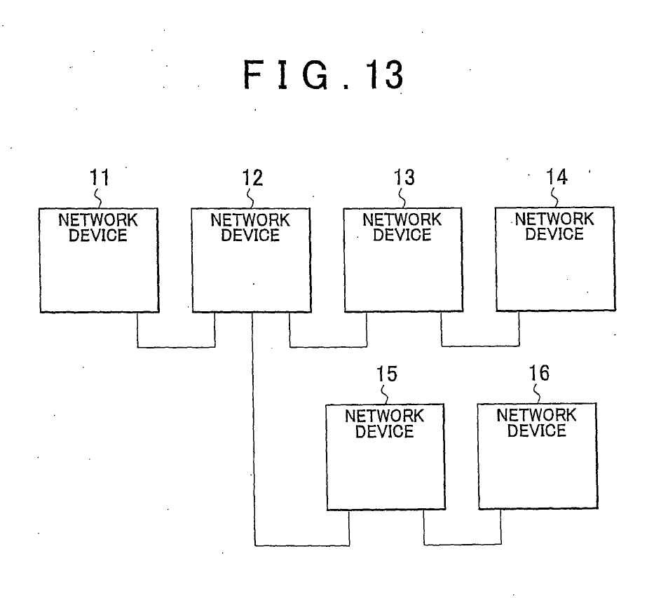

### DETAILED DESCRIPTION OF EMBODIMENTS

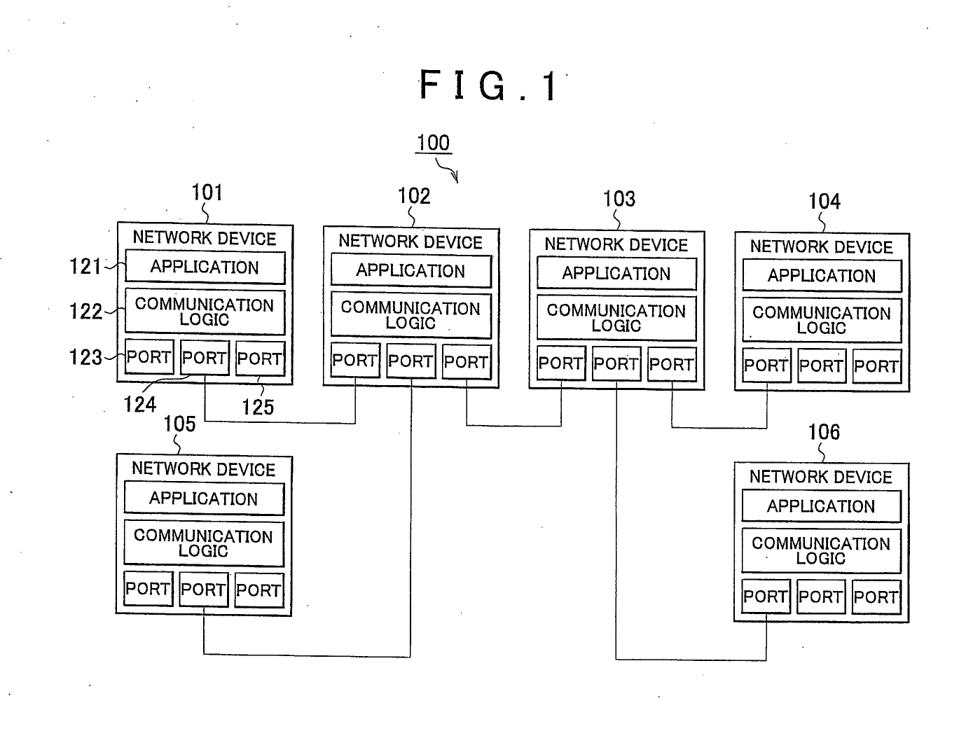

A specific embodiment 1 employing the invention will be described below in greater detail with reference to the appended drawings of the embodiment 1. FIG. 1 shows a general network configuration and a network device. As shown in FIG. 1, a network 100 has network devices 101 to 106.

Because the network devices 101 to 106 are identical in configuration, the network device 101 will be explained herein by way of example. The network device 101 has an application 121, a communication logic 122, and ports 123 to 125.

The application 121 generates data for use in another network device in the network or uses data generated in another network device. Examples of the application include generation of video data by using a peripheral device such as a camera and transmission of the video data to another network device and display of video data transmitted by another network device on a display.

The communication logic 122 is configured, for example, by a Media Access Control (MAC) bridge (including a switch, a rooting table, etc., for realizing bridge communication between a plurality of ports in the own device) specified by IEEE 802.1 or a circuit performing operation and control specified by a protocol such as a Spanning Tree Protocol (STP). Furthermore, the application 121 also divides the generated data to a predetermined length and performs control to add control information and obtain frames.

The ports 123 to 125 perform transmission and reception of frames between network devices. For example, a connector or a cable specified by IEEE 802.3 and hardware conforming to a transmission-reception protocol such as MAC can be used.

The communication logic 122 and application 121 a connected to adjacent network devices via the ports 123 to 125, thereby configuring the network 100. The configuration of connection between the network devices may be a daisy-chain connection composed of network devices 101 to 104 or connection of star type composed of network devices 101, 102, 103, and 105.

In each network device, a rooting table 143, which is to be described later, in the own device saves information indicating which port of the own device is connected to which port of another network device. As a result, even when a plurality of ports are used, as in the network device 102 or 103, communication between the ports of the adequate network device is performed on the basis of this information.

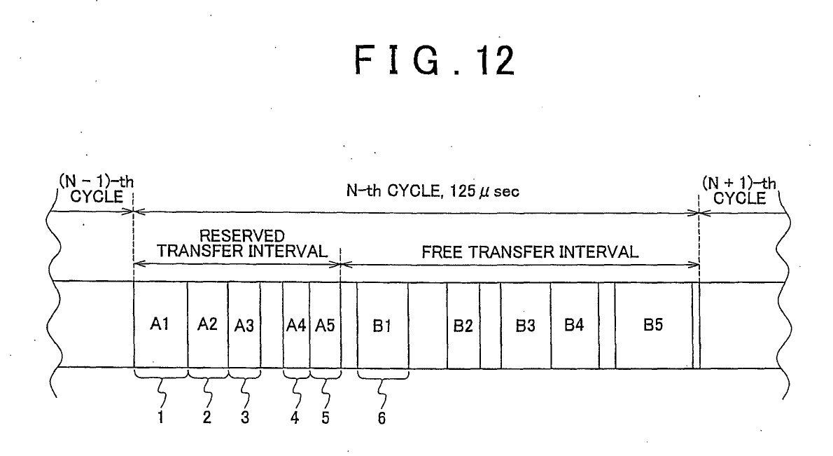

The network devices 101 to 106 of the above-described configuration perform transmission and reception of frames in cyclic transfer communication explained with reference to FIG. 12 in the network 100. Furthermore, in Embodiment 1, a synchronization frame including time information of a master clock that is a synchronization clock of the above-described network is arranged in the initial period of a timeslot.

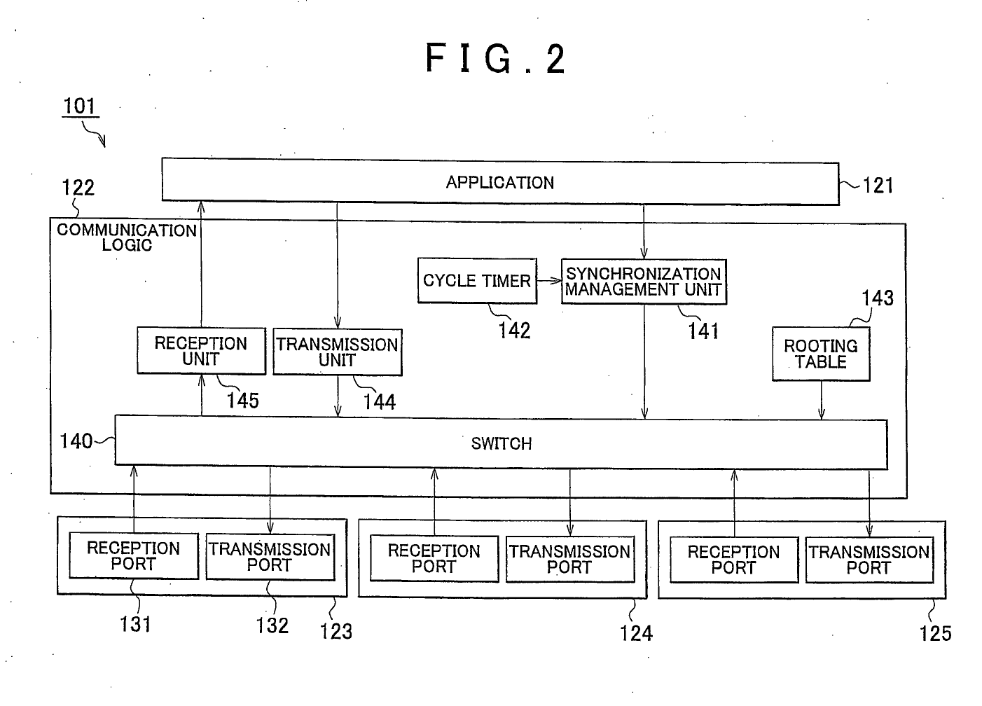

FIG. 2 shows in greater detail a configuration block diagram of the network devices 101 to 106 shown in FIG. 1. Because the network devices 101 to 106 are identical in configuration, the network device 101 will be explained hereinbelow by way of example. In FIG. 2 components denoted by the same reference numerals as in FIG. 1 have similar configuration and explanation thereof is herein omitted.

The communication logic 122 has a switch 140, a synchronization management unit 141, a cycle timer 142, a rooting table 143, a reception unit 144, and a transmission unit 145.

The rooting table 143 has information indicating which port of the device is connected to which port of another network device.

The switch 140 performs bridge communication between a plurality of ports in the own device, for example, between a reception port 131 of a port 123 and a transmission port 132 of a port 125. This bridge communication is performed based on header information of a frame received by the switch 140 and information of the rooting table 143. Accordingly, the received frame is correctly sent to the transmission port 132 to which the device that is a transmission destination is connected. Furthermore, the switch 140 sends a frame of the device address that has been received by the own device to the reception unit 145. It also has a function of sending a frame sent from the transmission unit 144 to the transmission port 132 of the designated port.

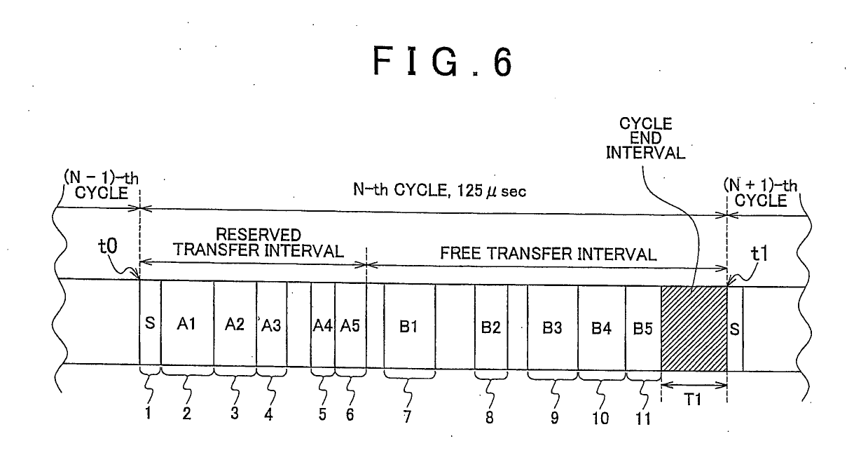

The cycle timer 142 measures a time within a timeslot having a predetermined period. For example, in a timeslot such as shown in the below-described FIG. 6, a 125 μsec interval from a timeslot start time t0 to an end time t1 is measured. The measured information is sent to the synchronization management unit 141.

The synchronization management unit 141 takes the last period of the timeslot such as shown in the below-described FIG. 6, for example, a period T1 from 110 μsec to 125 μsec as a cycle end interval and generates an end interval designation signal when the measurement information from the cycle timer 142 indicates that this interval is reached.

The end interval designation signal is sent to the switch 140 and frame transmission of the switch 140 in the cycle end interval is stopped. Furthermore, where a frame that has been transmitted in the cycle end interval is present in the switch 140, this frame is discarded. The end interval designation signal is sent till a synchronization frame present at the very beginning of the timeslot of the next cycle is received, and the received frame is not transferred to the switch 140. The length of the cycle end interval can be set by the application 121. A frame received in the end interval designation signal is either discarded or stored temporarily in a buffer. Furthermore, the transmission of a frame from the below-described transmission unit 144 is also stopped in the cycle end interval by the end interval designation signal.

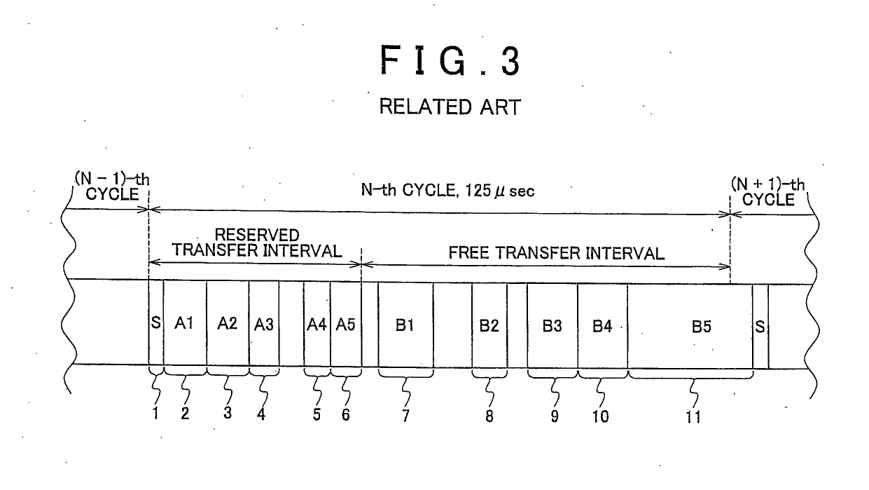

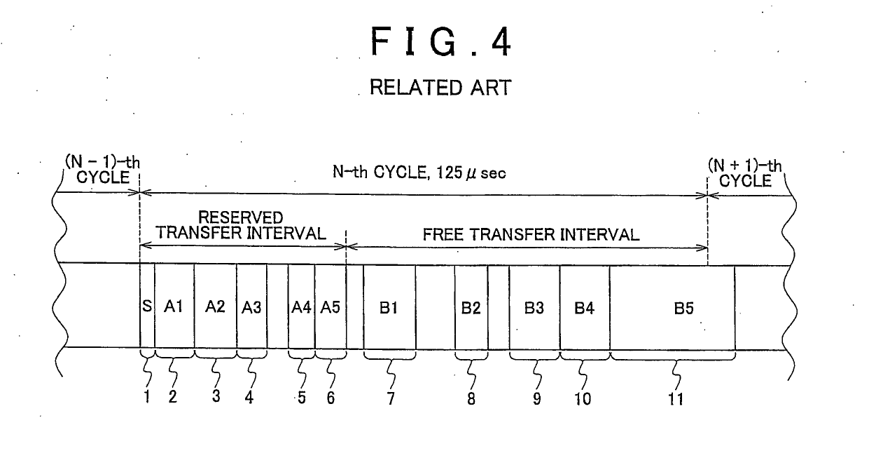

The outline of processing performed in the synchronization management unit 141 will be described below with reference to FIGS. 3 to 6. FIGS. 3 and 4 show a timeslot of an N-th cycle serving to illustrate problems associated with the related art, and FIG. 6 shows a timeslot of Embodiment 1.

As shown in FIGS. 3, 4, and 6, a synchronization frame S including time information of a master slot, which is a synchronization clock of the above-described network, is arranged in the initial period 1 of the timeslot of the N-th cycle. The synchronization frame is usually transmitted from a master device generating the master clock to each network device about every 2 sec. However, in the example, in order to simplify the explanation, the synchronization frame S will be assumed to be arranged in the initial period 1 of a time slot of each cycle. Furthermore, in FIGS. 3, 4, and 6, the synchronization frame S and frames A1 to A5 that will be transferred in the reserved transfer interval are arranged in the periods 1 to 6. Frames B1 to B5 that will be transferred in the free transfer interval are arranged in the periods 7 to 11. The synchronization frame S and frames A1 to A5 are reserved and transmitted in the same period at all times in the timeslot of each cycle.

In FIG. 3, the very last frame B5 of the free transfer interval in the N-th cycle is delayed due to network congestion and transmitted with a spread-out to the timeslot of the (N+1)-th cycle. As a result, the synchronization frame S of the (N+1)-th cycle is delayed and not transmitted in the initial period of the timeslot of the (N+1)-th cycle. Furthermore, the frame A1 that has to be usually transmitted is discarded.

In FIG. 4, likewise, the very last frame B5 of the free transfer interval in the N-th cycle is delayed due to network congestion and transmitted with a spread-out to the timeslot of the (N+1)-th cycle. As a result, a period for transmitting the synchronization frame S of the (N+1)-th cycle cannot be ensured and the synchronization frame S is not transmitted in the (N+1)-th cycle

These phenomena degrade the network synchronization accuracy. For example, when the transmission of frames within a timeslot is performed between the devices in a state in which the synchronization frame is not transferred, as in FIG. 4, the network device that usually has to receive a synchronization frame cannot receive the synchronization frame. In a specific example, the network device 101 shown in FIG. 1 is a master device, and the network device 104 has to receive a synchronization frame from the network device 101, but a case is possible in which network congestion occurs, synchronization frame transmission in the network device 102 or 103 is impossible, and the network device 104 cannot receive the synchronization frame from the network device 101.

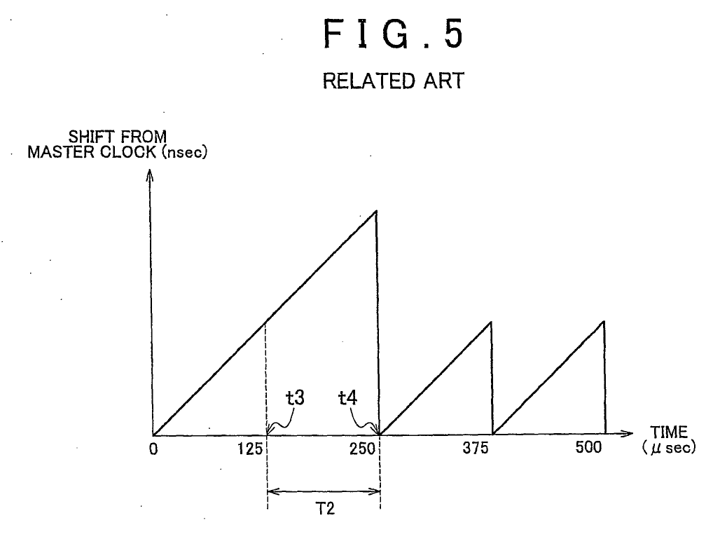

In this case the shift between the clock of the network device 104 and the master clock of the network device 101, which is the master device, becomes such as shown in FIG. 5. In FIG. 5, the elapsed time is plotted against the abscissa, and a shift between the clock of the own device and the master clock is plotted against the ordinate. As shown in FIG. 5, at a time t4, the shift between the clock of the network device 104 and the master clock becomes twice as large as the usual shift. Usually, at a time t3, the shift from the master clock has to be corrected and reduced to zero by a synchronization frame received by the network device 104. However, when the synchronization frame is not transferred in the path from the network device 101 to the network device 104 due to network congestion, this shift is not corrected before the time t4. As a result, the size of the shift increases, as shown in FIG. 5. The shift shown in FIG. 5 is corrected at the time t4, but when a state in which the network device 104 cannot receive the synchronization frame is maintained for the same reason as described above, the shift further increases. For this reason, it is highly probable that a frame transmitted from the network device 104 with a large shift in synchronization will collide with a frame transmitted from another network device.

In the network device of Embodiment 1, as shown in FIG. 6, no frame is transmitted within the very last period T1 (cycle end interval) of the free transfer interval in the timeslot of the N-th cycle. This is realized, as described hereinabove, by the synchronization management unit 141 that stops the frame transmission operation within the cycle end interval to the switch 140 by the interval designation signal once the cycle end interval is reached. Therefore, when the transmission of frame B5 shown in FIG. 6 enters the cycle end interval, this frame B5 is discarded or temporarily accumulated in the buffer (not shown in the figure) and resent in another cycle. Accordingly, as shown in FIG. 3 or FIG. 4, because the frame B5 does not spread out into the timeslot of the next cycle, the synchronization frame S arranged in the initial period of the timeslot is protected from being discarded. The discarded frame B5 is resent from a device that is a transmission source in a subsequent cycle.

As described hereinabove, in the network configured by the network device of Embodiment 1, even when network congestion occurs, a synchronization frame can be reliably transmitted within the initial period of the timeslot between network devices. Therefore, as explained hereinabove with reference to FIG. 5, a shift between the master clock and the clock of the own device does not increase and the network devices are synchronized, thereby preventing the aforementioned collision of frames. As a result, the network configured by the network device of Embodiment 1 can operate with good stability.

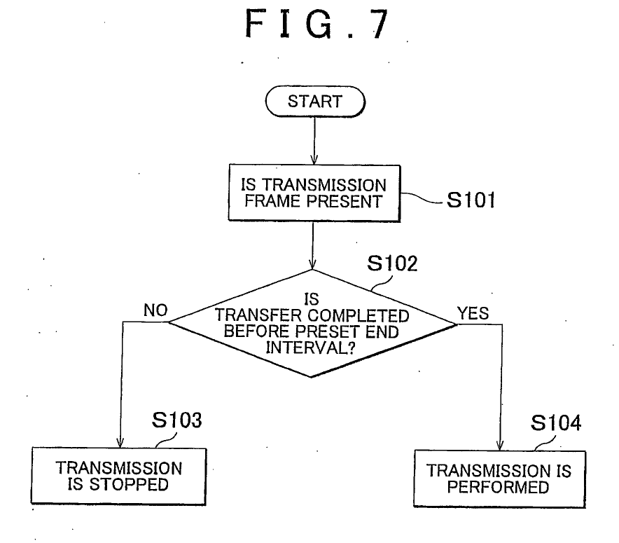

The processing flows of the synchronization management unit 141 and cycle timer 142 will be described below by using the flowchart shown in FIG. 7. When a frame that is being transferred to the switch 140 is present (S101), the synchronization management unit 141 determines whether the frame transfer is completed before the cycle end interval that has been set (S102). This determination can be made with reference to the cycle timer on the basis of whether the length (=time) of the frame that is to be transferred can be transferred before the cycle ends. The frame time as referred to herein is determined by a byte width (for example 1 byte) of data within the frame and a communication rate (for example, 1 Gbps) of the network (for example, 8 nsec). When it is determined that the transfer is not completed before the cycle end interval (S102, No), an end interval designation signal is sent from the synchronization management unit 141 to the switch 140 and, the frame transfer is interrupted (S103). When it is determined that the transfer is completed before the cycle end interval (S102, Yes), the end interval designation signal is not sent from the synchronization management unit 141 to the switch 140, and the switch 140 performs the frame transfer (S104).

The transmission unit 144 receives data from the application 121, adds address information of the network device that is the transmission destination to the data to generate a frame for transmission, and sends this frame to the switch 140. The frame for transmission is transmitted to the network device with the designated transmission destination. With respect to this frame, the switch 140 terminates the transmission under control of the synchronization management unit 141 in the cycle end interval. The application 121 can prevent the frame from being discarded by processing of the cycle end interval of another device by transmitting a frame to the transmission unit 144 with consideration for the length of the cycle end interval or network delay between the devices.

The reception unit 145 receives via the switch 140 the frame of the own device address received from the network and sends data located in the frame to the application 121.

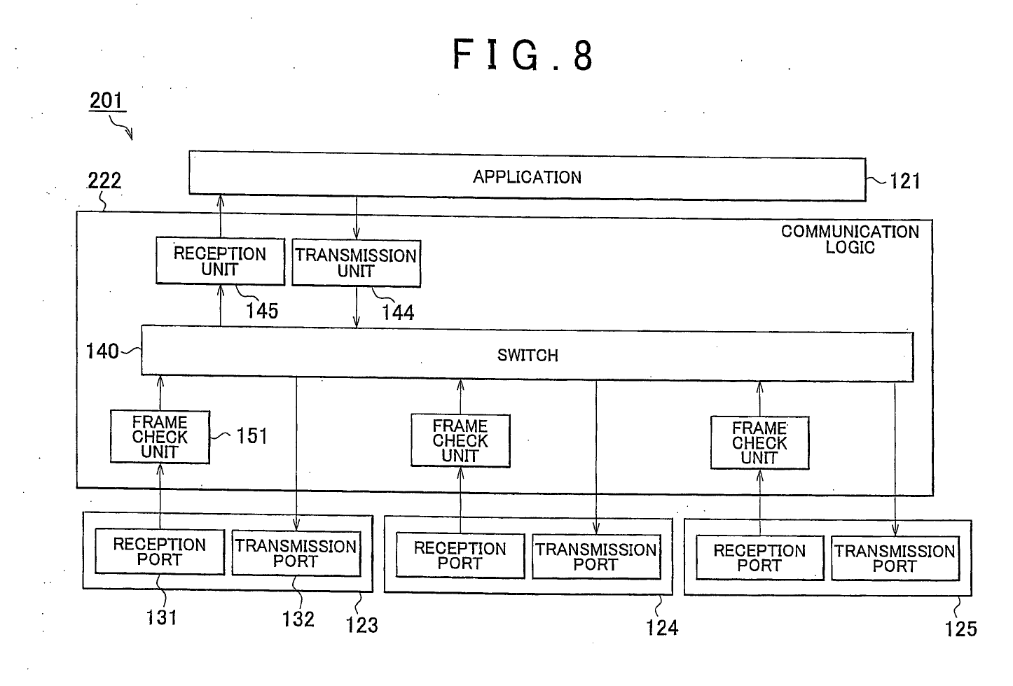

A network device 201 of Embodiment 2 of the invention will be explained below in detail with reference to the appended drawings. FIG. 8 is a structural block diagram of the network device. Similarly to Embodiment 1, a network device 201 will be described by way of example. This embodiment differs from Embodiment 1 in a portion of communication logic 222. Therefore, the explanation will be focused on this portion. Components denoted by the same reference symbols as in Embodiment 1 have similar configuration and explanation thereof is herein omitted.

The communication logic 222 has a switch 140, a frame check unit 151, a transmission unit 144, and a reception unit 145.

In addition to the processing explained in Embodiment 1, the switch 140 sends to the frame check unit 151 information indicating whether a transmission port 132 connected to the frame transmission destination is in the frame transfer process.

Where the frame check unit 151 checks a synchronization frame arranged in the initial period of the timeslot in each cycle of cyclic transfer communication, the frame check unit determines based on information from the switch 140 as to whether the transmission port 132 connected to a device that is a transfer destination of the synchronization frame is in the frame transfer process. When the switch 140 performs frame transmission at this time, the frame transmission of the switch 140 is stopped (with will be referred to hereinbelow as “transfer stop processing:”) and the synchronization frame is transferred preferentially (this will be referred to hereinbelow as “priority processing”).

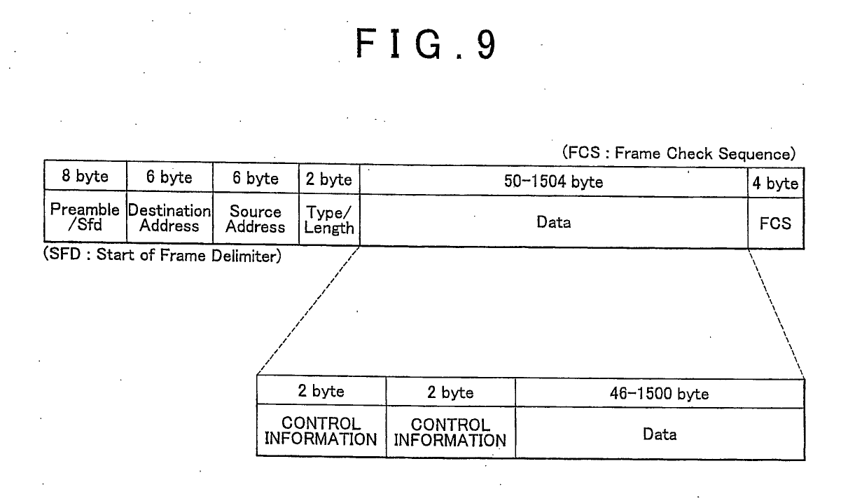

FIG. 9 shows an example of a synchronization frame for performing synchronization control of network devices. This synchronization frame will be assumed to be generated according to IEEE 802.3. In the MAC frame of IEEE 802.3, a 7 byte Preamble, a 1 byte Start of Frame Delimiter (SFD), a 6 byte Destination Address, a 6 byte Source Address, and a 2 byte Type are arranged in the frame header. These are followed by Data, and finally an Frame Check Sequence (FCS) is arranged. In Embodiment 2, 4 byte control information is arranged at the very end of the header, that is, at the leading end of Data. This control information indicates whether the frame is a synchronization frame. The frame check unit 151 determines whether the frame is a synchronization frame on the basis of this control information and performs the above-described processing when the frame is a synchronization frame.

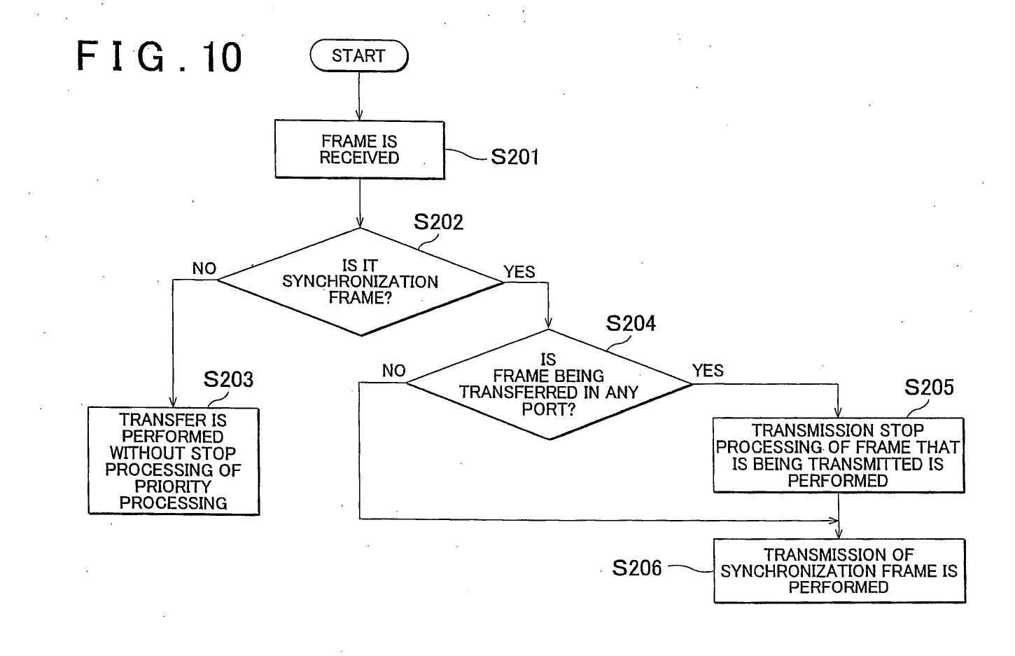

The processing flows of the frame check unit 151 and switch 140 will be described below by using the flowchart shown in FIG. 10. When the frame check unit 151 receives a frame (S201), the frame check unit determines whether the received frame is a synchronization frame (S202). When the received frame is not a synchronization frame (S202, No), the frame check unit 151 transfers the received frame, without performing the stop processing or priority processing with respect to the switch 140 and (S203).

By contrast, when the received frame is a synchronization frame (S202, Yes), the frame check unit 151 determines whether the transmission port 132 that transmits the received frame, which is a synchronization frame, is in the process of transferring another frame (S204). Where the transmission port 132 is not in the process of transferring another frame (S204, No), the transmission port performs the transmission of the received frame, which is a synchronization frame (S206). Where the transmission port is in the process of transferring another frame (S204, Yes), the transfer stop processing of the other frame is performed (S205) and the received frame, which is a synchronization frame, is transmitted (S206). Here, the sequential processing of steps S204 and S205 corresponds to the above-described priority processing.

As described hereinabove, in the network device of Embodiment 2, the received synchronization frame is preferentially transferred to another device. This is performed in the following manner. When the frame check unit 151 receives a synchronization frame, where the transmission port 132 for transferring the synchronization frame is in the process of transmitting another frame, the frame check unit causes the switch 140 to stop the transmission of the other frame and preferentially transmit the synchronization frame. As a result, in the network configured by the network device of Embodiment 2, transmission and reception of the synchronization frame between the network devices is not delayed by network congestion. Therefore, the network devices are synchronized with good stability. Accordingly, the network can operate with good stability.

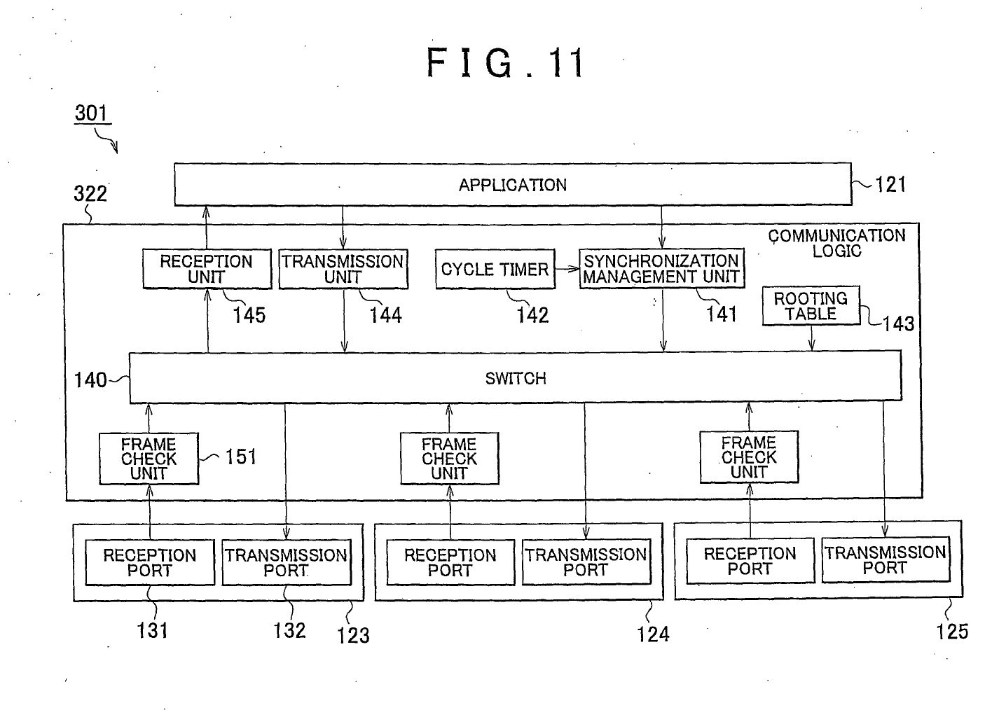

A network device of Embodiment 3 of the invention will be explained below in detail with reference to the appended drawings. FIG. 11 is a structural block diagram of the network device. Similarly to Embodiments 1 and 2, a network device 101 is used by way of example. The network device 301 of Embodiment 3 has the functions of both the network device 101 of Embodiment 1 and the network device 201 of Embodiment 2. Therefore, a communication logic 322 differs from the communication logic 122 of Embodiment 1 and the communication logic 222 of Embodiment 2. Accordingly, the explanation will be focused on this portion. Components denoted by the same reference symbols as in Embodiments 1 and 2 have similar configuration and explanation thereof is herein omitted.

The communication logic 322 has a switch 140, a synchronization management unit 141, a cycle timer 142, a rooting table 143, a transmission unit 144, a reception unit 145, and a frame check unit 151. Configurations of these components are similar to those of Embodiment 1 and Embodiment 2 and explanation thereof is herein omitted.

The network device of Embodiment 3 has functions of both the network device of Embodiment 1 and the network device of Embodiment 2. Therefore, by not transmitting a frame in the cycle end interval, the synchronization frame is protected, and when the synchronization frame is received, the synchronization frame is preferentially transmitted. Therefore, transmission and reception of a synchronization frame transferred between network devices in a network can be performed more reliably than in the cases in which Embodiment 1 and Embodiment 2 are implemented individually. Therefore, the network can operate with even better stability.

The invention is not limited to the above-described embodiments and appropriate changes can be made without departing from the scope of the invention.

1-14. (canceled)

15. A network system comprising:
a plurality of network devices within a network, wherein
a cyclic data transfer is performed, in which transmission data are divided into a plurality of frames and the plurality of frames are transmitted and received in fixed cycles;
a synchronization frame, including time information of a master clock, that synchronizes clocks of the plurality of network devices by correcting a shift between the master clock and the clock of the network device, is arranged and transferred in an initial period of the cycle; and
each of the network devices measures a time within the cycle and prohibits frame transmission to another network device, for a predetermined period, in each cycle till a start of a next cycle on the basis of information relating to the measured time for preventing the synchronization frame from being discharged.

16. The network system according to claim 15, wherein when a frame received from another network device in the predetermined period exists, the network device discards or temporarily stores the received frame.

17. The network system according to claim 15, wherein when the network device further receives the synchronization frame and a frame that is being transferred to another network device exists, the network device stops transmission of the frame that is being transferred and preferentially transmits the synchronization frame.

18. The network system according to claim 17, wherein the network device discards or temporarily stores the frame that is being transferred.

19. The network system according to claim 15, wherein the synchronization frame is one that is specified in IEEE 1588.

20. A frame transfer method of performing a cyclic data transfer, in which transmission data are divided into a plurality of frames and the plurality of frames are transmitted and received in fixed cycles, and arranging and transferring a synchronization frame that synchronizes a plurality of network devices within a network in an initial period of the cycle,
the method comprising:
measuring a time within the cycle; and
suspending frame transmission for a predetermined period in each cycle till a start of a next cycle on the basis of information relating to the measured time.

21. The frame transfer method according to claim 20, further comprising:
discarding or temporarily storing the received frame when there is a frame received in the predetermined period exists.

22. The frame transfer method according to claim 20, further comprising:
stopping transmission of the frame that is being transmitted when the synchronization frame is received and transmitting the synchronization frame.

23. The frame transfer method according to claim 22, wherein the frame that is being transferred uses a transmission port identical to that used for transmitting the synchronization frame.

24. The frame transfer method according to claim 22, wherein the frame that is being transferred is discarded or temporarily stored.
